(19) United States
(12) Patent Application Publication
(10) Pub. No.: US 2025/0222754 A1
(43) Pub. Date: Jul. 10, 2025

(54) VEHICLE LOWER PART STRUCTURE

(71) Applicant: TOYOTA JIDOSHA KABUSHIKI KAISHA, Toyota-shi (JP)

(72) Inventors: Kota SAKONAKA, Okazaki-shi (JP); Masao Tsukada, Gotemba-shi (JP); Ikuo Tachi, Numazu-shi (JP); Mitsuhiro Futsuta, Toyota-shi (JP); Masashi Katoh, Toyota-shi (JP); Hamiyu Seki, Nagoya-shi (JP)

(73) Assignee: TOYOTA JIDOSHA KABUSHIKI KAISHA, Toyota-shi (JP)

(21) Appl. No.: 18/909,796

(22) Filed: Oct. 8, 2024

(30) Foreign Application Priority Data
Jan. 10, 2024 (JP) 2024-001937

(51) Int. Cl. B60K 1/04

(52) U.S. Cl. CPC B60K 1/04; B60K 2001/0438

(57) ABSTRACT

The present disclosure relates to a vehicle lower part structure. The vehicle lower part structure is a vehicle lower part structure in which a battery is mounted, and includes a first cushioning material disposed in the vicinity of the vehicle center so as to be sandwiched between the battery and the floor panel in the vehicle vertical direction.

### CROSS-REFERENCE TO RELATED APPLICATION

This application claims priority to Japanese Patent Application No. 2024-001937 filed on Jan. 10, 2024, incorporated herein by reference in its entirety.

### BACKGROUND

### 1. Technical Field

The disclosure relates to a vehicle lower part structure.

### 2. Description of Related Art

There is proposed a vehicle lower part structure provided in a vehicle in which a battery is mounted on a floor, mainly for the purpose of protecting the battery. For example, there is a structure in which a member is disposed so as to surround a side surface of a battery, in order to reduce a collision load on the battery when a collision occurs from the side surface of the vehicle. In addition, there is a structure in which a cushioning material is provided on a floor to protect a battery from a load applied during a collision.

Japanese Unexamined Patent Application Publication No. 2021-123227 (JP 2021-123227 A) discloses a mounting structure of a battery pack disposed on a floor of a vehicle. In this mounting structure, the battery pack includes battery cells, a battery pack case in which the battery cells are disposed, and a cushioning member disposed between the battery cells and the battery pack case. In this structure, the battery pack case is fixed to the floor, so that the cushioning member is disposed so as to be sandwiched between the battery cells and the floor, or between the battery cells and the battery pack case. Therefore, with this mounting structure, the battery cells can be securely fixed with a simple configuration while ensuring high reliability.

### SUMMARY

Here, in a vehicle equipped with a battery, installation of a reinforcement for increasing the strength of a vehicle body in the vicinity of the center of a floor is occasionally abolished. In this case, when the vehicle is traveling on a road surface, the amount of vertical deformation of the floor increases due to vibration in the vicinity of the center of the floor (that is, in the vicinity where a center tunnel and a floor cross are disposed). As a result, the riding comfort of the vehicle may deteriorate. Therefore, there is a desire to improve riding comfort by reducing vibration transmitted from the road surface during travel. However, the cushioning member that is used for the purpose of protecting the battery described above has low rigidity and cannot suppress the vertical deformation of the floor.

Therefore, the present specification provides a vehicle lower part structure that protects a battery by providing a cushioning material between the battery and a floor panel in the vicinity of the center of a floor, and that suppresses vibration of a vehicle body while a vehicle is traveling by improving the rigidity in the vicinity of the center of the floor.

An aspect of the present disclosure provides
a vehicle lower part structure equipped with a battery, including
a first cushioning material disposed near a vehicle center so as to be sandwiched between the battery and a floor panel in a vehicle up-down direction.

According to the above aspect, the first cushioning material suppresses vibration between the battery and the floor panel, so that the rigidity of the floor near the center of the vehicle and the periphery thereof can be increased.

The first cushioning material may be provided near a floor tunnel of a floor.

According to the above configuration, it is possible to increase the rigidity in the vicinity of the floor tunnel, in particular.

The vehicle lower part structure may further include a second cushioning material provided near a center of the floor panel provided between the floor tunnel and a mounting portion of the battery to a vehicle in a vehicle width direction, the second cushioning material being provided on an outer with respect to the first cushioning material. The first cushioning material may be configured to be more rigid than the second cushioning material.

According to the above configuration, by setting the rigidity of the second cushioning material to be lower than that of the first cushioning material while securing the rigidity of the first cushioning material, it is possible to suppress the loosening of the fastening portion between the battery and the vehicle at the mounting portion of the battery to the vehicle in the vicinity of the second cushioning material.

According to the vehicle lower part structure disclosed herein, it is possible to increase the rigidity of the floor near the center of the vehicle and the periphery of the floor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view schematically illustrating a floor of a vehicle to which a vehicle lower part structure according to an embodiment is applied;

FIG. 2 is a graphical representation of per-frequency inertance in the vehicle lower part structure of FIG. 1; and

FIG. 3 is a graph showing vibration levels for each frequency in the vehicle lower part structure of FIG. 1.

### DETAILED DESCRIPTION OF EMBODIMENTS

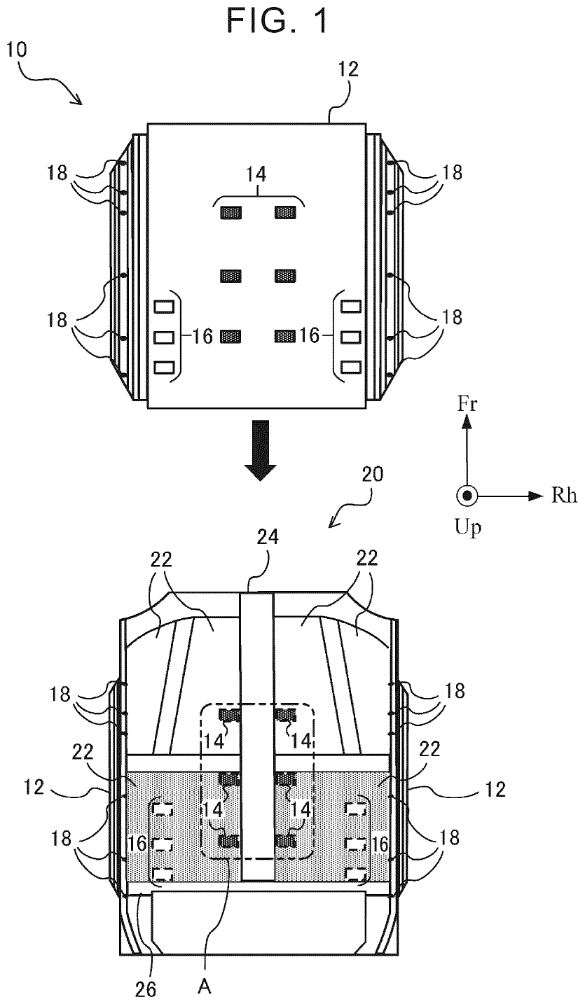

Hereinafter, a vehicle lower part structure will be described with reference to the drawings. In FIG. 1, “Fr”, “Up”, and “Rh” indicate a front side, an upper side, and a right side, respectively.

FIG. 1 is a plan view schematically illustrating a floor of a vehicle to which a vehicle lower part structure according to an embodiment is applied. As shown in FIG. 1, the vehicle lower part structure 10 is a structure of a vehicle on which a battery 12 is mounted. First cushioning materials 14 and second cushioning materials 16 are disposed on an upper surface of the battery 12 in the vehicle up-down direction. Further, the battery 12 is attached to the vehicle at the bolt fastening portion 18. In FIG. 1, the first cushioning materials 14 are shown as dark ink portions. The bolt fastening portion 18 is shown as a black oval shape.

The bottom view of the bold arrow shown in FIG. 1 is a plan view showing the floor 20 of the vehicle. More specifically, the lower view of the thick arrow is a view showing a structure in which the above-described battery 12 (indicated by the upper view of the thick arrow) is overlaid with the floor 20 and its lower and peripheral members from above. In this figure, the battery 12 is located below the floor 20, so that most of it is hidden in plan view by the floor 20. Therefore, in this figure, only portions of both ends of the battery 12 in the vehicle width direction, that is, portions not hidden by the floor 20, appear.

As illustrated in FIG. 1, the floor 20 includes a floor panel 22, a floor tunnel 24, and a center floor cross 26. Note that, as will be described later, in the floor panel 22, the floor panel to which the second cushioning materials 16 are attached is indicated by a thin ink portion in order to distinguish it from the others. Further, in a plan view, the first cushioning materials 14 and the second cushioning materials 16 disposed below the floor 20 are hidden, and thus are shown as hidden lines by broken lines.

Next, the configuration of the vehicle lower part structure 10 will be further described with reference to FIG. 1. As described above, the vehicle lower part structure 10 includes the battery 12, the first cushioning materials 14, the second cushioning materials 16, and the floor panel 22 in this order from the bottom in the vehicle vertical direction. That is, the first cushioning materials 14 and the second cushioning materials 16 are disposed so as to be sandwiched between the battery 12 and the floor panel 22 in the vertical direction. Further, the floor panel 22 is configured to be supported from below by the battery 12 to which the first cushioning materials 14 and the second cushioning materials 16 are attached. The battery 12 is supported by a vehicle body by another structural member.

Further, as shown in FIG. 1, in the vehicle lower part structure 10, a plurality of the first cushioning materials 14 and a plurality of the second cushioning materials 16 are provided. In the present example, the first cushioning materials 14 and the second cushioning materials 16 are provided in a total of six cushioning materials, three cushioning materials are provided on the left and the right, but the number is not limited thereto. In addition, a plurality of first cushioning materials 14 and a plurality of second cushioning materials 16 are not necessarily provided on the left and right sides. For example, it is also possible to provide one first cushioning material 14 on each of right and left sides in the vicinity of both sides of the floor tunnel 24. In this case, the first cushioning material 14 may not have a small rectangular shape as shown in FIG. 1. For example, the first cushioning material 14 may have a substantially rectangular shape having a long side in the vehicle front-rear direction. However, in the case where the first cushioning material extends along the floor tunnel 24 and has a larger shape than the first cushioning material 14 of the present example, problems such as a hindrance to installation of other members around the floor 20 and a cause of an increase in mass may occur. Therefore, in this example, the plurality of the first cushioning materials 14 and the plurality of the second cushioning materials 16 are provided on the left and right, the workability of the assembly, with comprehensive consideration of the mass, the cost, and the like.

Next, the first cushioning materials 14 will be further described. The first cushioning materials 14 are disposed so as to be vertically sandwiched between the battery 12 and the floor panel 22 in the vicinity of the vehicle center. More specifically, the first cushioning materials 14 are provided near the floor tunnel 24. As described above, in general, in a vehicle equipped with a battery, the reinforcement may not be installed near the center of the floor. For example, by omitting the reinforcement, the lower end position of the battery can be made relatively high. Therefore, the rigidity in the vicinity of the center of the floor is reduced. Specifically, the rigidity of the portion A (hereinafter, referred to as “vicinity A of the center”) surrounded by the rounded rectangle of the two-dot chain line in FIG. 1 decreases. The battery 12 and the floor panel 22 have different natural frequencies. Therefore, in a case where some member such as a reinforcement that suppresses vibration between the battery 12 and the floor panel 22 is not installed, vibration during vehicle traveling is not suppressed particularly with respect to the floor panel 22. As a result, the vibration of the floor panel 22 such as the vicinity A of the center increases, and the riding comfort of the passenger in the vehicle may deteriorate. Therefore, in the present example, by arranging the first cushioning materials 14 in the vicinity A of the center of the floor 20, the vibration in the vertical direction of the floor 20 in the vicinity A of the center (in other words, the deformation amount in the vertical direction) is suppressed.

The first cushioning materials 14 of the present example supports the floor panel 22 moving in the up-down direction due to vibration during traveling together with the battery 12, and serves to suppress vibration in which the floor panel 22 and the battery 12 interact with each other. Therefore, the first cushioning materials 14 are set to have sufficient rigidity to suppress vibration of the floor panel 22 and to support the floor panel 22 together with the battery 12. That is, the first cushioning materials 14 are different from a cushioning material having a low rigidity, such as a cushioning material used for the purpose of conventional battery protection. The first cushioning materials 14 are set so as to further improve the rigidity than the rigidity (for example, an image such as a solidified sponge) required to serve as a cushioning material between the original battery 12 and the floor panel 22.

Next, the second cushioning materials 16 will be further described. As described above, the second cushioning materials 16 are provided on the upper surface of the battery 12 and on the lower surface of the floor panel 22 indicated by the thin ink portion in FIG. 1. That is, the second cushioning materials 16 are disposed so as to be sandwiched in the vertical direction between the battery 12 and the floor panel 22, similarly to the first cushioning materials 14. The second cushioning materials 16 are provided in the vicinity of the center of the floor panel 22 indicated by the thin ink portion and outside the first cushioning materials 14. Therefore, the second cushioning materials 16 are provided at positions closer to the bolt fastening portion 18 than the first cushioning materials 14. At this time, if the rigidity of the second cushioning materials 16 is set in the same manner as that of the first cushioning materials 14 having improved rigidity as described above, inconvenience may occur in the bolt fastening portion 18. That is, when the rigidity of the second cushioning materials 16 is high, there may be a problem that bolts are not tightened in the bolt fastening portion 18, which is a portion near both end portions of the battery 12 and attached to the vehicle. Therefore, the rigidity of the second cushioning materials 16 is set lower than that of the first cushioning materials 14. With such a configuration, it is possible to avoid a state in which the battery 12 is firmly attached to the vehicle in the second cushioning material 16 portions (that is, an image in which the battery 12 is hardened by the second cushioning materials 16). As a result, loosening of the fastening at the fastening portion (that is, the bolt fastening portion 18) between the battery 12 and the vehicle can be suppressed.

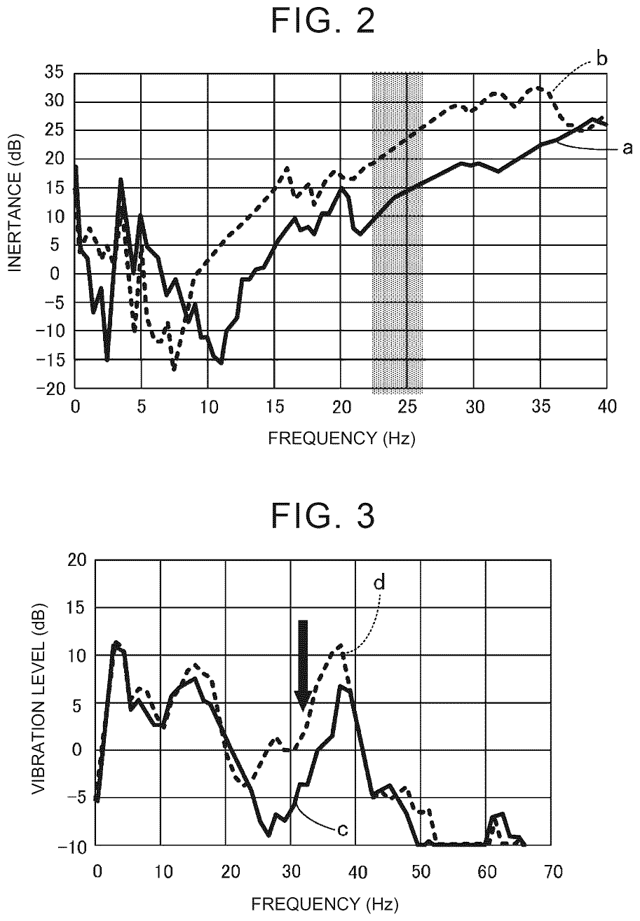

By the above-described vehicle lower part structure, the vertical vibration of the floor 20 is verified to what extent different from the conventional one, and an example thereof is shown in FIGS. 2 and 3. Here, FIG. 2 is a graph showing inertance for each frequency in the vehicle lower part structure of FIG. 1, and FIG. 3 is a graph showing vibration levels for each frequency in the vehicle lower part structure of FIG. 1.

More specifically, the graph shown in FIG. 2 is a graph representing the vertical vibration of the floor 20 in the vicinity of the floor tunnel 24, which is a part of the center floor cross 26. In FIG. 2, the inertance for each frequency of the vehicle lower part structure according to the embodiment is indicated by a solid line a. Further, in FIG. 2, the inertance for each frequency of the conventional vehicle lower part structure (that is, the structure in which the first cushioning materials 14 and the second cushioning materials 16 are not attached in the embodiment) is indicated by a half broken line b. Note that the inertance is one of transfer functions in the vibration field, and is a ratio of a force input to an object and an acceleration that may be generated by the force. Various information such as a resonance frequency and an attenuation factor can be obtained from the transfer function such as the inertance. Here, as is clear from the comparison between the solid line a and the half broken line b in FIG. 2, the inertance is significantly different between the vehicle lower part structure according to the embodiment and the conventional vehicle lower part structure within the range indicated by the thin ink portion. Then, when the rigidity is determined based on the result of the inertance, one result that the rigidity around the center floor cross 26 in the vehicle lower part structure according to the embodiment is improved by about three times as compared with the conventional vehicle lower part structure is obtained.

Next, the vertical vibration of the floor 20 in the vehicle lower part structure according to the embodiment is verified at a position other than the vicinity of the rear end of the floor tunnel 24, such as the center floor cross 26. The graph shown in FIG. 3 is a graph showing the vertical vibration of the traveling vehicle in the vicinity of the front side of the floor 20, more specifically, the front seat rail (not shown) of the front seat. In FIG. 3, the vibration level for each frequency of the vehicle lower part structure according to the embodiment is indicated by a solid line c. In FIG. 3, the vibration level of each frequency of the conventional vehicle lower part structure (that is, the structure in which the first cushioning materials 14 and the second cushioning materials 16 are not attached in the embodiment) is indicated by a half broken line d. As is obvious from the comparison between the solid line c and the half-broken line d in FIG. 3, the vibration level is significantly different between the vehicle lower part structure according to the embodiment and the conventional vehicle lower part structure, particularly at a portion indicated by a black arrow. That is, in the present verification, one result that the vibration level at the front side of the floor 20 in the vehicle lower part structure according to the embodiment is greatly reduced as compared with the conventional vehicle lower part structure is obtained.

Note that the above description is merely an example, and in the vehicle lower part structure disclosed in this specification, it is sufficient that the vehicle lower part structure includes a first cushioning material disposed so as to be sandwiched between the battery and the floor panel in the vehicle vertical direction in the vicinity of the vehicle center. Therefore, other configurations may be changed as appropriate. For example, the shape, size, quantity, and material of the first cushioning material and the second cushioning material are not particularly limited. As an example, the rigidity of the first cushioning material and the second cushioning material may be set to be different by using different materials. As another example, the first cushioning material and the second cushioning material may be formed of the same material, and the hardness may be changed by varying the amount of crushing (i.e., the degree of compression) of each material. In addition, foamed resins having different degrees of foaming can also be used.

What is claimed is:

1. A vehicle lower part structure equipped with a battery, comprising a first cushioning material disposed near a vehicle center so as to be sandwiched between the battery and a floor panel in a vehicle up-down direction.

2. The vehicle lower part structure according to claim 1, wherein the first cushioning material is provided near a floor tunnel of a floor.

3. The vehicle lower part structure according to claim 2, further comprising a second cushioning material provided near a center of the floor panel provided between the floor tunnel and a mounting portion of the battery to a vehicle in a vehicle width direction, the second cushioning material being provided on an outer with respect to the first cushioning material, wherein the first cushioning material is configured to be more rigid than the second cushioning material.
